(19) United States
(12) Patent Application Publication
(10) Pub. No.: US 2012/0019961 A1
(43) Pub. Date: Jan. 26, 2012

(54) METHOD OF SEEK TRAJECTORY GENERATION FOR BETTER TRACKING AND FASTER SETTLING IN HARD DISK DRIVES

(75) Inventors: Dong Jun Lee, San Jose, CA (US); Chang Ik Kang, Santa Clara, CA (US); Bong Jin Lee, Fremont, CA (US)

(73) Assignee: Samsung Electronics Co., Ltd., Suwon City (KR)

(21) Appl. No.: 12/843,264

(22) Filed: Jul. 26, 2010

(51) Int. Cl. G11B 5/56

(52) U.S. Cl. 360/294.5; G9B/5.201

(57) ABSTRACT

A hard disk drive with a circuit that controls a voice coil motor. The circuit provides a driving current to the voice coil motor to move a head of the drive in a seek routine. The seek routine includes a computation of a driving current that is a function of a feedforward zero phase error tracking algorithm. Utilizing the feedforward zero phase error tracking algorithm can reduce the seek time of the drive.

### BACKGROUND OF THE INVENTION

1. Field of the Invention

The present invention relates to a seek routine of a hard disk drive.

2. Background Information

Hard disk drives contain a plurality of magnetic heads that are coupled to rotating disks. The heads write and read information by magnetizing and sensing the magnetic fields of the disk surfaces. Each head is attached to a flexure arm to create a subassembly commonly referred to as a head gimbal assembly (“HGA”). The HGA's are suspended from an actuator arm. The actuator arm has a voice coil motor that can move the heads across the surfaces of the disks.

Information is typically stored in radial tracks that extend across the surface of each disk. Each track is typically divided into a number of segments or sectors. The voice coil motor and actuator arm can move the heads to different tracks of the disks.

FIG. 1 shows a typical track that has a number of fields associated with each sector. A sector may include an automatic gain control (“AGC”) field 1 that is used to adjust the strength of the read signal, a sync field 2 to establish a timing reference for the circuits of the drive, and ID 3 and Gray Code 4 fields to provide sector and track identification.

Each sector may have also a servo field 5 located adjacent to a data field 6. The servo field 5 contains a plurality of servo bits A, B, C and D that are read and utilized in a servo routine to position the head 7 relative to the track. By way of example, the servo routine may utilize the algorithm of ((A−B)−(C−D)) to create a position error signal (“PES”). The PES is used to create a drive signal for the voice coil motor to position the head on the track.

The drive will enter a seek routine to access data at different disk tracks. During a seek routine a requested address location is provided and a corresponding seek time and drive current is calculated to drive the voice coil motor and move the heads to the desired location. Before the head arrives at the desired disk location the seek routine enters a settle mode. In the settle mode the head velocity is reduced until the head reaches the desired track. It is generally desirable to minimize the seek time during operation of a disk drive to improve the speed of reading and writing data in the drive.

### BRIEF SUMMARY OF THE INVENTION

A hard disk drive with a circuit that controls a voice coil motor. The circuit provides a driving current to the voice coil motor to move a head of the drive in a seek routine. The seek routine includes a computation of a driving current that is a function of a feedforward zero phase error tracking algorithm.

### BRIEF DESCRIPTION OF THE DRAWINGS

FIG. 1 is an illustration of a track of the prior art;

FIG. 2 is a top view of an embodiment of a hard disk drive;

FIG. 3 is a schematic of an electrical circuit for the hard disk drive;

FIG. 4 is a schematic of a control system for the hard disk drive;

FIG. 5 is a graph showing a reduction is seek time when a seek routine utilizes a feedforward zero phase error tracking algorithm.

### DETAILED DESCRIPTION

Described is a hard disk drive with a circuit that controls a voice coil motor. The circuit provides a driving current to the voice coil motor to move a head of the drive in a seek routine. The seek routine includes a computation of a driving current that is a function of a feedforward zero phase error tracking algorithm. Utilizing the feedforward zero phase error tracking algorithm can reduce the seek time of the drive.

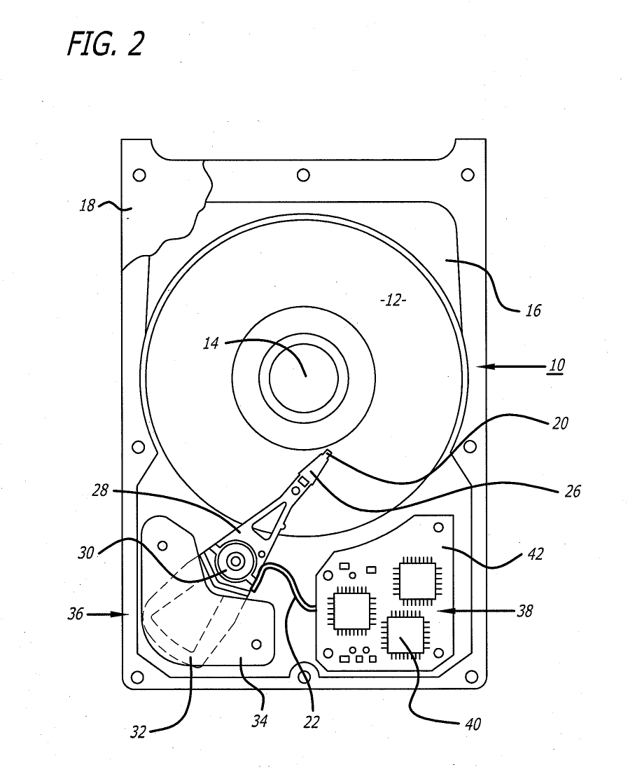

Referring to the drawings more particularly by reference numbers, FIG. 2 shows an embodiment of a hard disk drive 10. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. Each head 20 may have separate write and read elements. The write element magnetizes the disk 12 to write data. The read element senses the magnetic fields of the disks 12 to read data. By way of example, the read element may be constructed from a magneto-resistive material that has a resistance which varies linearly with changes in magnetic flux.

Each head 20 may be gimbal mounted to a suspension arm 26 as part of a head gimbal assembly (HGA). The suspension arms 26 are attached to an actuator arm 28 that is pivotally mounted to the base plate 16 by a bearing assembly 30. A voice coil 32 is attached to the actuator arm 28. The voice coil 32 is coupled to a magnet assembly 34 to create a voice coil motor (VCM) 36. Providing a current to the voice coil 32 will create a torque that swings the actuator arm 28 and moves the heads 20 across the disks 12.

The hard disk drive 10 may include a printed circuit board assembly 38 that includes one or more integrated circuits 40 coupled to a printed circuit board 42. The printed circuit board 40 is coupled to the voice coil 32, heads 20 and spindle motor 14 by wires (not shown).

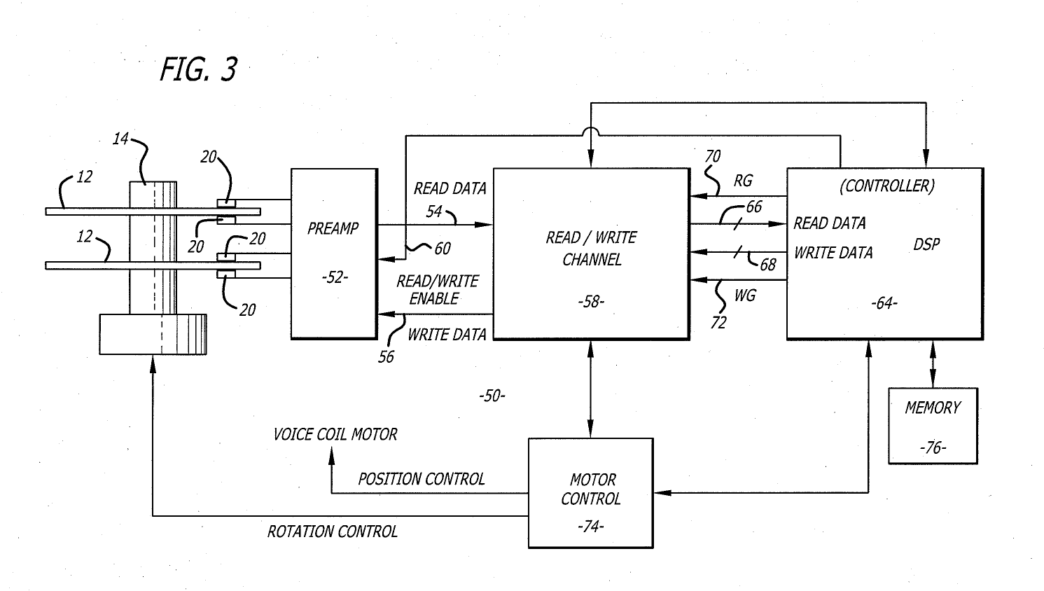

FIG. 3 shows an electrical circuit 50 for reading and writing data onto the disks 12. The circuit 50 may include a pre-amplifier circuit 52 that is coupled to the heads 20. The pre-amplifier circuit 52 has a read data channel 54 and a write data channel 56 that are connected to a read/write channel circuit 58. The pre-amplifier 52 also has a read/write enable gate 60 connected to a controller 64. Data can be written onto the disks 12, or read from the disks 12 by enabling the read/write enable gate 60.

The read/write channel circuit 58 is connected to a controller 64 through read and write channels 66 and 68, respectively, and read and write gates 70 and 72, respectively. The read gate 70 is enabled when data is to be read from the disks 12. The write gate 72 is enabled when writing data to the disks 12. The controller 64 may be a digital signal processor that operates in accordance with a software routine, including a routine(s) to write and read data from the disks 12. The read/write channel circuit 58 and controller 64 may also be connected to a motor control circuit 74 which controls the voice coil motor 36 and spindle motor 14 of the disk drive 10. The controller 64 may be connected to a non-volatile memory device 76. By way of example, the device 76 may be a read-only memory (“ROM”) that contains instructions that are read by the controller 64.

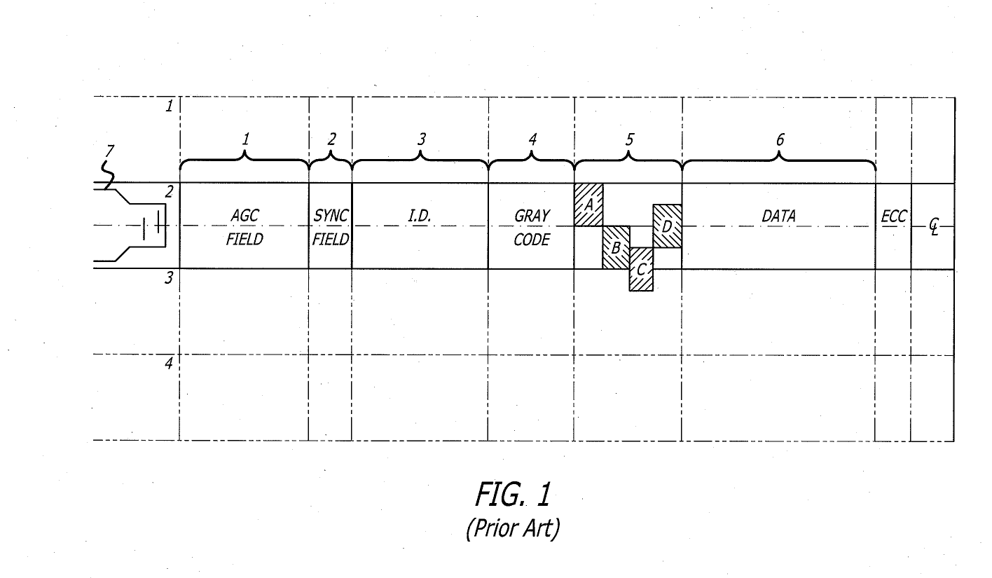

Each sector of a disk track typically has servo bits A, B, C and D as shown in FIG. 1. The controller 64 may operate a servo routine utilizing the servo bits to position the head relative to the track. The head is moved in accordance with a position error signal (“PES”). The PES reflects the difference between a target position and the actual position of the head.

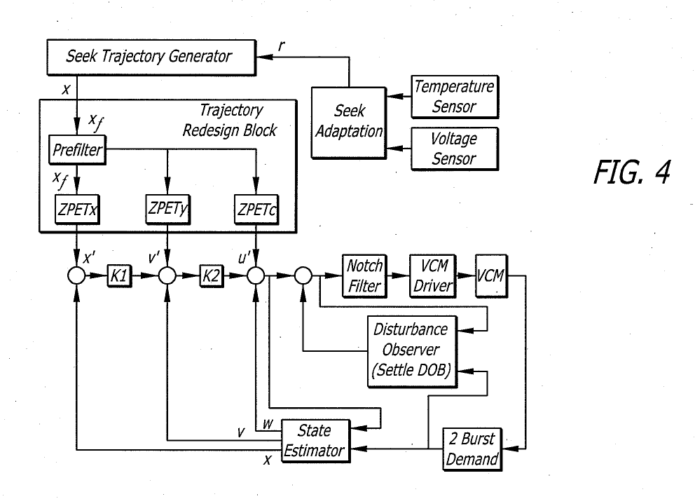

FIG. 4 shows a schematic of a control system 100 used to perform a seek operation. The control is typically performed by the controller 64. In a seek operation the heads are moved from one track location to another track location.

A current trajectory is provided to the voice coil motor 36 to move the heads to the desired track. The system 100 includes a voice coil motor driver 102 and notch filter 104 connected to the voice coil. The driver 102 provides a drive current to the voice coil 36.

The system includes a seek adaptation block 106 that initiates a seek routine and generates a desired head position. The adaptation block 106 receives feedback from a temperature sensor 108 and a voltage sensor 110. A seek trajectory generator 112 receives the desired head position and generates current, velocity and head position trajectories.

The trajectories are modified by a trajectory redesign block 114. The trajectory redesign block 114 utilizes a zero phase error tracking algorithm (“ZPET”) to modify the trajectories. A zero phase error tracking algorithm insures a zero phase error between the desired head position and an actual head position. The drive current can be modified in accordance with the following equations, where equation (1) is a zero order hold discretized actuator model.

$$\begin{matrix}\frac{x ( k )}{i ( k )} = K \frac{( z + 1 )}{{( z - 1 )}^{2}} & ( 1 ) \\ \frac{{i}^{*} ( k )}{x ( k )} = \frac{{( z - 1 )}^{2} ( {z}^{- 1} + 1 )}{4 K} = ZPETc ( z ) \\ Hence , \\ {i}^{*} ( k ) = \frac{1}{4 K} \frac{{z}^{3} - {z}^{2} - z + 1}{{z}^{3}} x ( k + 2 ) & ( 2 ) \\ \frac{{v}^{*} ( k )}{x ( k )} = \frac{{v}^{*} ( k )}{{i}^{*} ( k )} \frac{{i}^{*} ( k )}{x ( k )} = \frac{4 K}{( z - 1 )} ZPETc ( z ) = ZPETv ( z ) \\ Hence , \\ {v}^{*} ( k ) = \frac{( {z}^{2} - 1 )}{{z}^{2}} x ( k + 1 ) & ( 3 )\end{matrix}$$

where

x(k)=a desired position.

i(k)=a drive current trajectory.

i*(k)=a modified current trajectory.

K=a plant gain

z=a transform factor.

The velocity trajectory can be modified with the following equations.

$$\begin{matrix}\frac{{v}^{*} ( k )}{x ( k )} = \frac{{v}^{*} ( k )}{{i}^{*} ( k )} \frac{{i}^{*} ( k )}{x ( k )} & ( 4 ) \\ = \frac{4 K}{( z - 1 )} ZPETc ( z ) = ZPETv ( z ) & ( 5 ) \\ Hence , {v}^{*} ( k ) = \frac{( {z}^{2} - 1 )}{{z}^{2}} x ( k + 1 ) & ( 6 )\end{matrix}$$

where

v*(k)=a modified velocity trajectory.

The head position trajectory can be modified with the following equations:

$$\begin{matrix}\frac{{x}^{*} ( k )}{x ( k )} = \frac{{x}^{*} ( k )}{{i}^{*} ( k )} \frac{{i}^{*} ( k )}{x ( k )} & ( 7 ) \\ = K \frac{( z + 1 )}{{( z - 1 )}^{2}} ZPETc ( z ) = ZPETx ( z ) & ( 8 ) \\ Hence , {x}^{*} ( k ) = \frac{{( z + 1 )}^{2}}{4 {z}^{2}} x ( k + 1 ) & ( 9 )\end{matrix}$$

where

x*(k)=a modified head position trajectory.

$${x}_{f} ( k ) = \frac{{( z + 1 )}^{2}}{4 {z}^{2}} x ( k + 1 ) \qquad ( 10 )$$

The trajectory redesign block 114 may also have one or more zero phase error prefilters to reduce seek acoustics. The filter may have the following form.

The system 100 may include a 2 burst demod block 116 that provides feedback regarding the actual position of the head. The actual head position is provided to a state estimator 118 that implements feed forward control of the system. The estimator 118 provides position x, velocity v and torque w estimates that are added to the outputs of the trajectory redesign block. The system may also include gain blocks 120 and 122, and a disturbance observer 124.

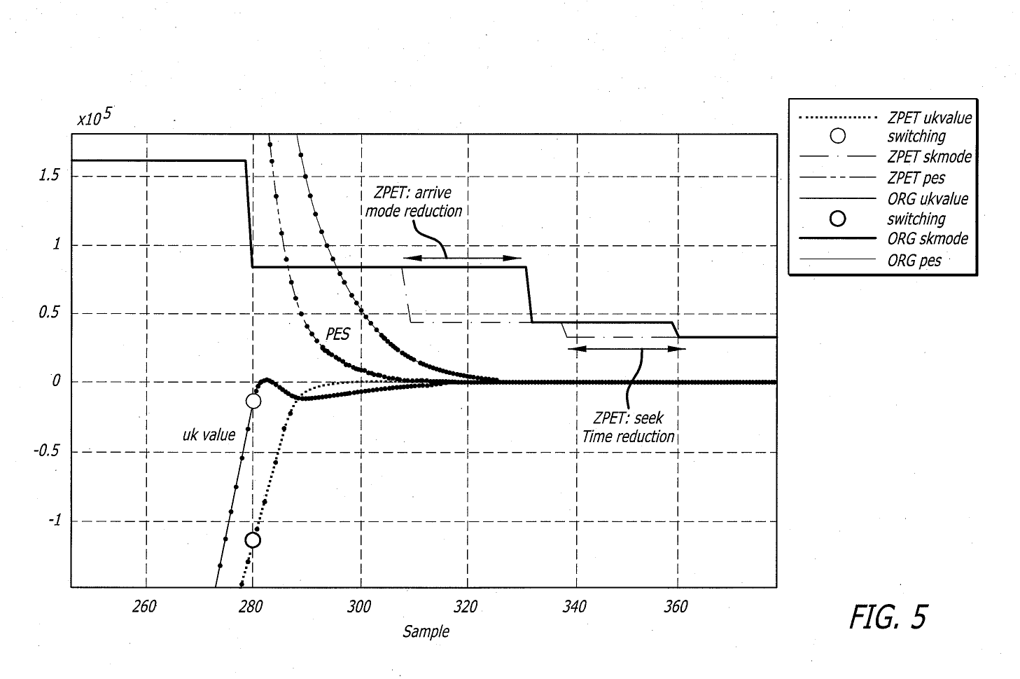

FIG. 5 shows seek times for a drive that utilizes the feedforward zero phase error tracking algorithm. As shown by FIG. 5, the utilization of the feedforward zero phase error tracking algorithm can reduce seek time.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A hard disk drive, comprising:
a disk;
a head coupled to said disk;
an actuator arm coupled to said head;
a voice coil motor coupled to said actuator arm; and,
a circuit coupled to said voice coil motor, said circuit provides a driving current to said voice coil motor to move said head in a seek routine, said seek routine includes a computation of said driving current that is a function of a feedforward zero phase error tracking algorithm.

2. The hard disk drive of claim 1, wherein said seek routine includes a computation of a velocity trajectory that is a function of the feedforward zero phase tracking algorithm.

3. The hard disk drive of claim 2, wherein said seek routine includes a computation of a head position trajectory that is a function of the feedforward zero phase tracking algorithm.

4. The hard disk drive of claim 1, wherein said seek routine includes a zero phase error tracking pre-filter.

5. A program storage medium that causes a seek routine in a hard disk drive, comprising:
a program storage medium that includes a program that causes a controller to perform a seek routine to move a head relative to a disk, the seek routine includes a computation of a driving current that is a function of a feedforward zero phase error tracking algorithm.

6. The program storage medium of claim 5, wherein said seek routine includes a computation of a velocity trajectory that is a function of the feedforward zero phase tracking algorithm.

7. The program storage medium of claim 6, wherein said seek routine includes a computation of a head position trajectory that is a function of the feedforward zero phase tracking algorithm.

8. The program storage medium of claim 5, wherein said seek routine includes a zero phase error tracking pre-filter.

9. A method for moving a head across a disk of a hard disk drive, comprising:
computing a drive current for a voice coil motor that can move a head relative to a disk, the drive current is a function of a feedforward zero phase tracking algorithm; and,
moving a head across a disk in a seek routine in response to the drive current.

10. The method of claim 9, further comprising computing a velocity trajectory that is a function of the feedforward zero phase tracking algorithm and used to compute the driving current.

11. The method of claim 10, further comprising computing a head position trajectory that is a function of the feedforward zero phase tracking algorithm and is used to compute the driving current.

12. The method of claim 9, wherein the driving current is computed using a zero phase error tracking pre-filter.
